(19) United States
(12) Patent Application Publication
(10) Pub. No.: US 2020/0268147 A1
(43) Pub. Date: Aug. 27, 2020

(54) DJ P.E.T. " DJ Promotional Event Table "

(71) Applicant: Juan Santos Gadia, Valley Cottage, NY (US)

(72) Inventor: Juan Santos Gadia, Valley Cottage, NY (US)

(73) Assignee: Juan Santos Gadia, Valley Cottage, NY (US)

(21) Appl. No.: 16/798,155

(22) Filed: Feb. 21, 2020

Related U.S. Application Data
(60) Provisional application No. 62/918,959, filed on Feb. 21, 2019.

(51) Int. Cl. A47B 37/00; A47F 5/10; A47F 5/00; A47B 3/08; A47F 11/10; G10G 5/00

(52) U.S. Cl. CPC A47B 37/00; A47F 5/108; A47F 5/0018; G10G 5/005; A47B 3/0818; A47F 11/10; A47B 3/08

(57) ABSTRACT

A self-propelled table characterized by its collapsible legs and lockable wheels. The collapsible legs unfold when rolled out of a compact space and conversely, folds when pushed in. The table includes two poles that are extendable and retractable and is configured to support hanging lighting and banners. In addition, the table contains a side compartment for holding small objects and an attached elevated desk to support small devices such as laptops and flat screen televisions up to 42 inches. There are two optional poles, one is electric and one is manual crank. Both the crank and electric poles are designed for mobile Disc Jockeys tables as the maximum weight capacity is 50 lbs.

### BRIEF DESCRIPTION OF DRAWINGS

The following illustrations from FIG. 1 to FIG. 1.5 shows different angles of the invention.

FIG. 1 is an overview of the invention with aluminum table top on it.

FIG. 1.1 It's angle where the Levers and it's lock are visible.

FIG. 1.2 An image of the invention where both tilting laptop computer holder and the poles are attached, poles here extended.

FIG. 1.3 An image of the invention where both tilting laptop computer holder and the poles are attached, poles here are retracted.

FIG. 1.4 An angle where two of the roll-in roll-out wheels are visible.

FIG. 1.5 The view of the DJ table frame without aluminum table top.

### BRIEF SPECIFICATION

These is a specialty table designed for Disc Jockeys and promoters.

This is a smart table, a cart, table with built in laptop computer holder and electric poles.

This is a time and energy saver for the user. Disc Jockey's basic equipment can possibly be loaded all at once and can avoid going back and forth.

### SUMMARY

This is a specialty table designed for mobile Disc Jockeys this is good for indoor and outdoor promotional events.

It's a multi-purpose table: it can be used as a cart for transporting basic DJ equipment that has a built-in tilting laptop holder and or TV stand, a semi-permanent linear actuators or detachable crank poles that are extendable and retractable to hold T-bar for DJ lighting or promotional overhead banner. It has a detachable side tray/compartment to hold a computer adapter or electrical surge outlet. The DJ P.E.T. table frame, tabletop and legs are made of aluminum alloy and the attachments i.e. side tray, tilting computer table and T-bar are made of stainless steel. The table has four foldable legs with individual wheels for transport. The two rear wheels are swiveling for easy maneuver. Four smaller wheels are for roll-in and roll-out.

Four legs with lockable wheels can be easily folded when loading to the service vehicle by pressing the two levers. During unloading, simply slide-out the table and the legs will open by itself. It has four lockable wheels for safety and stability.

### DETAILED DESCRIPTION

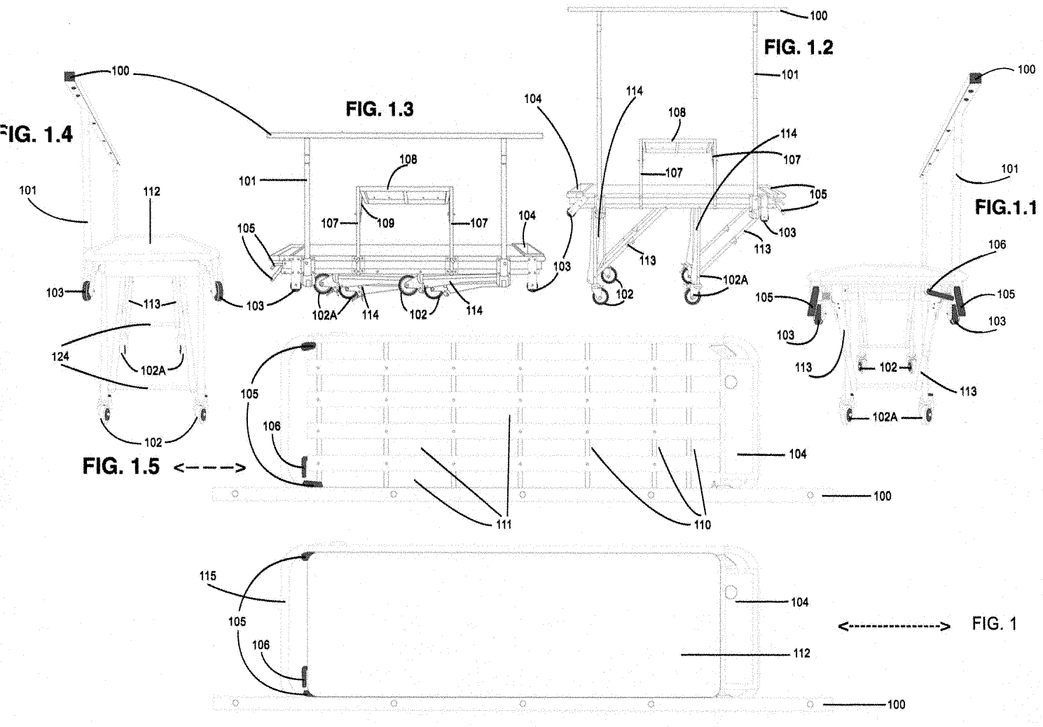

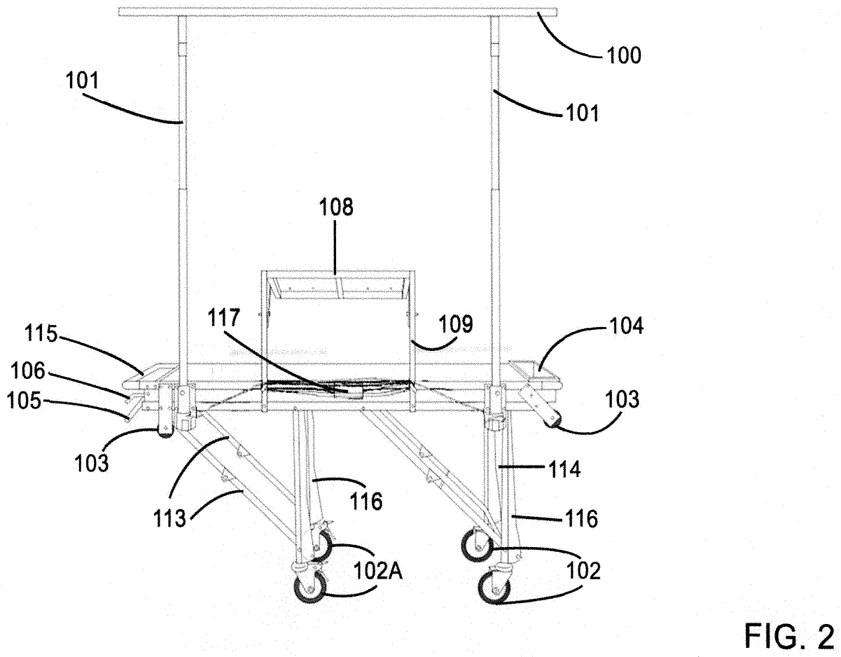

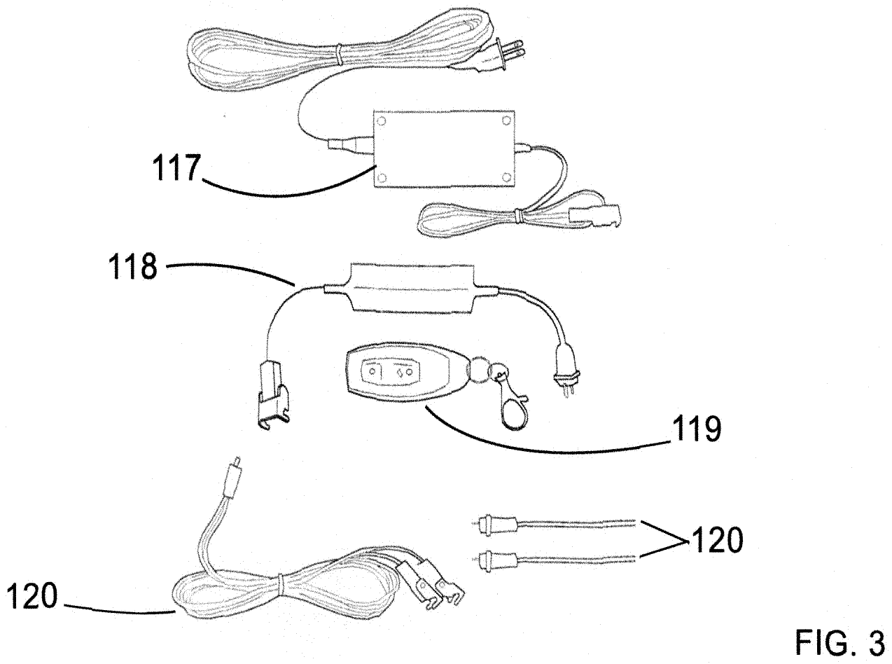

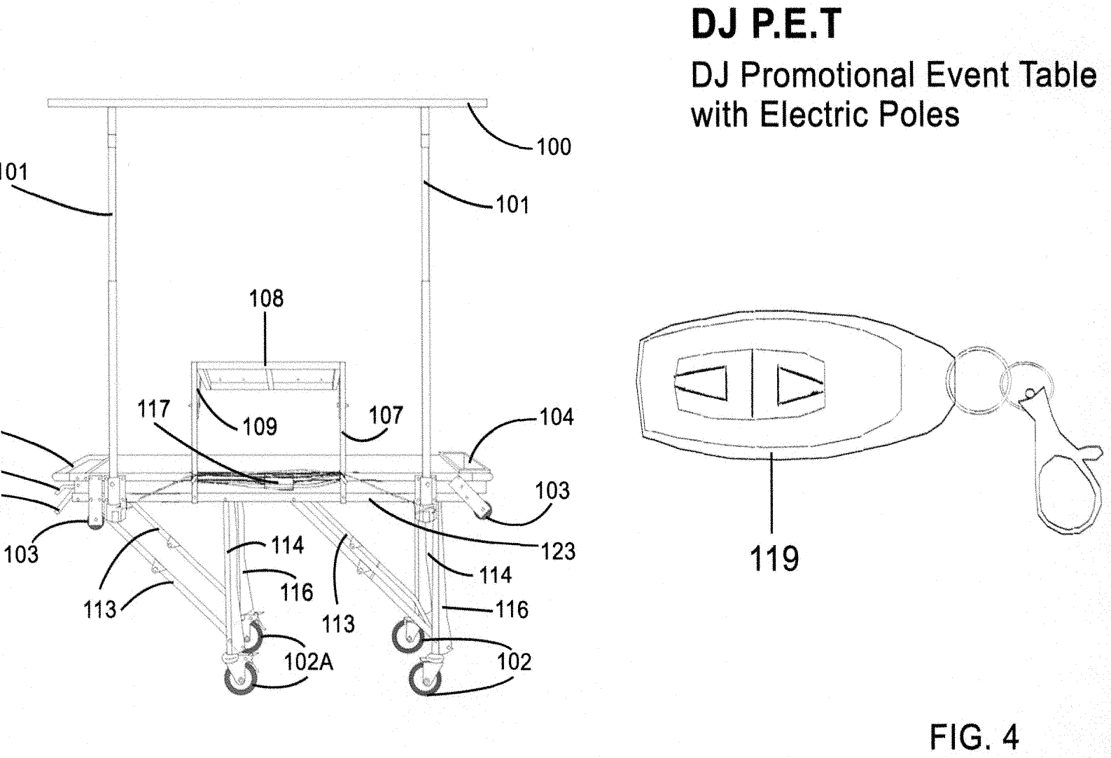

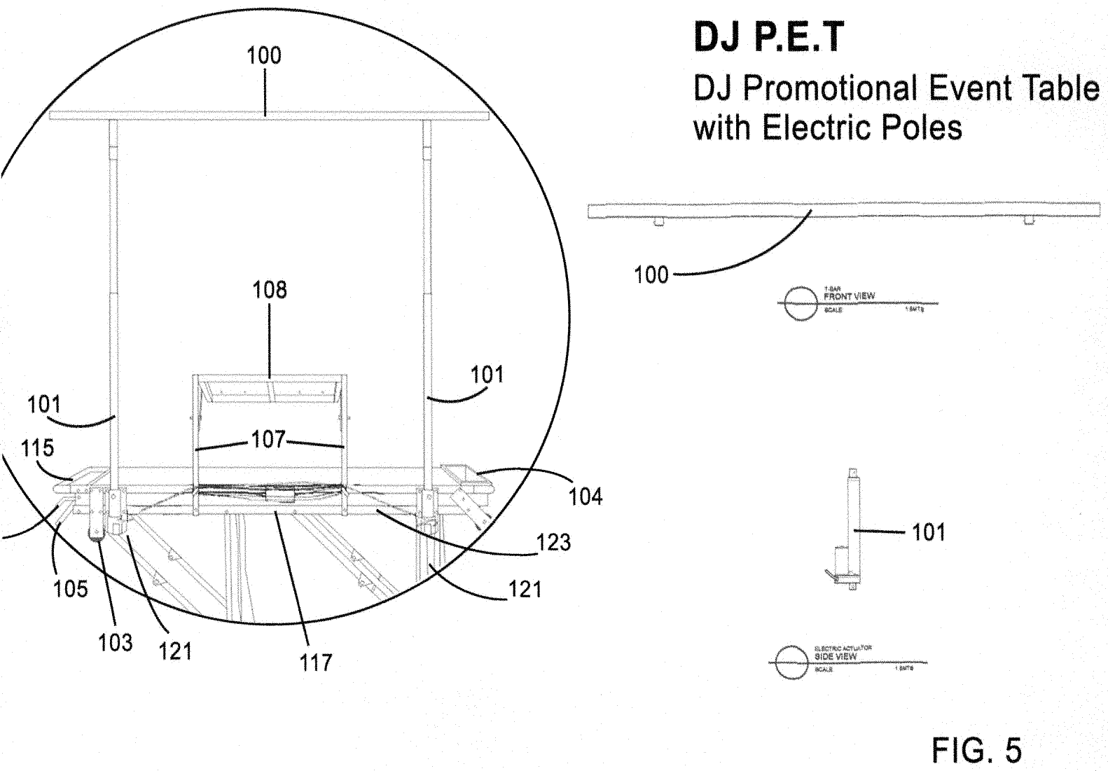

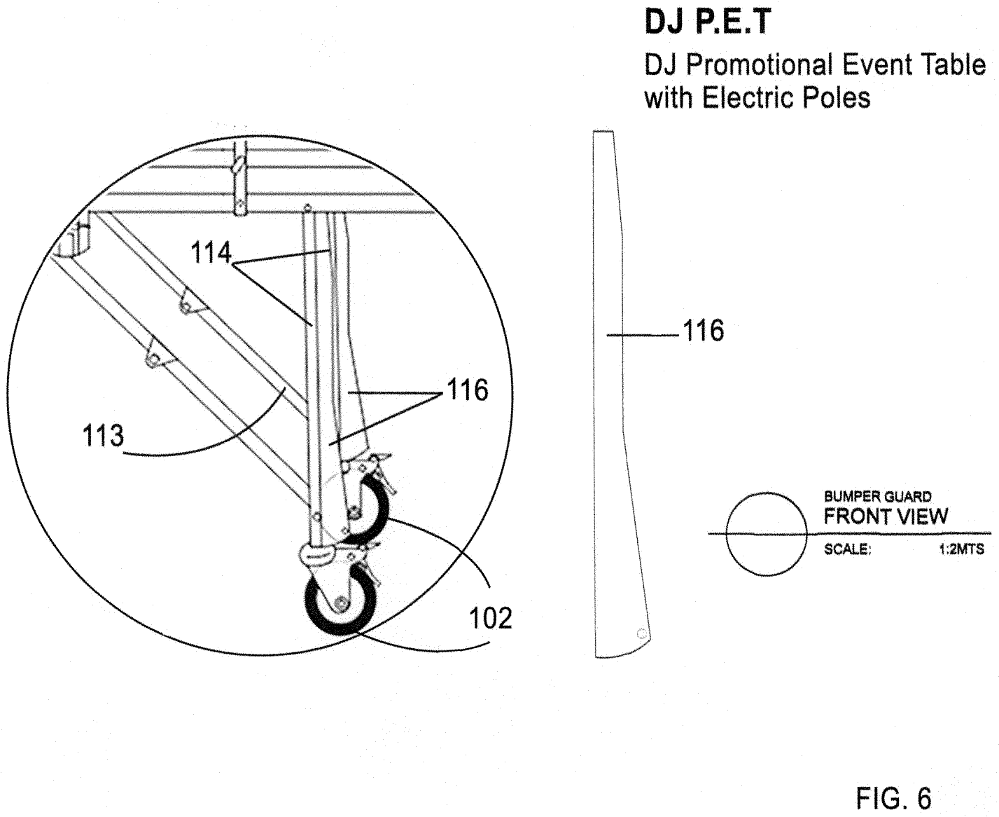

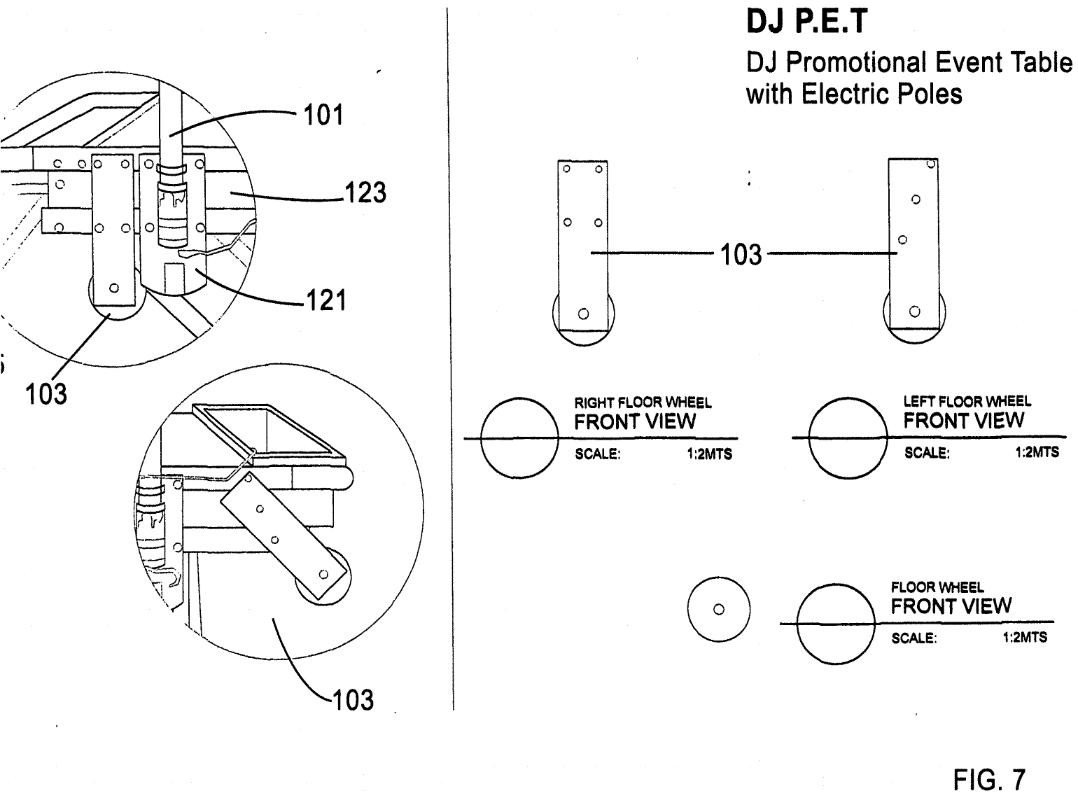

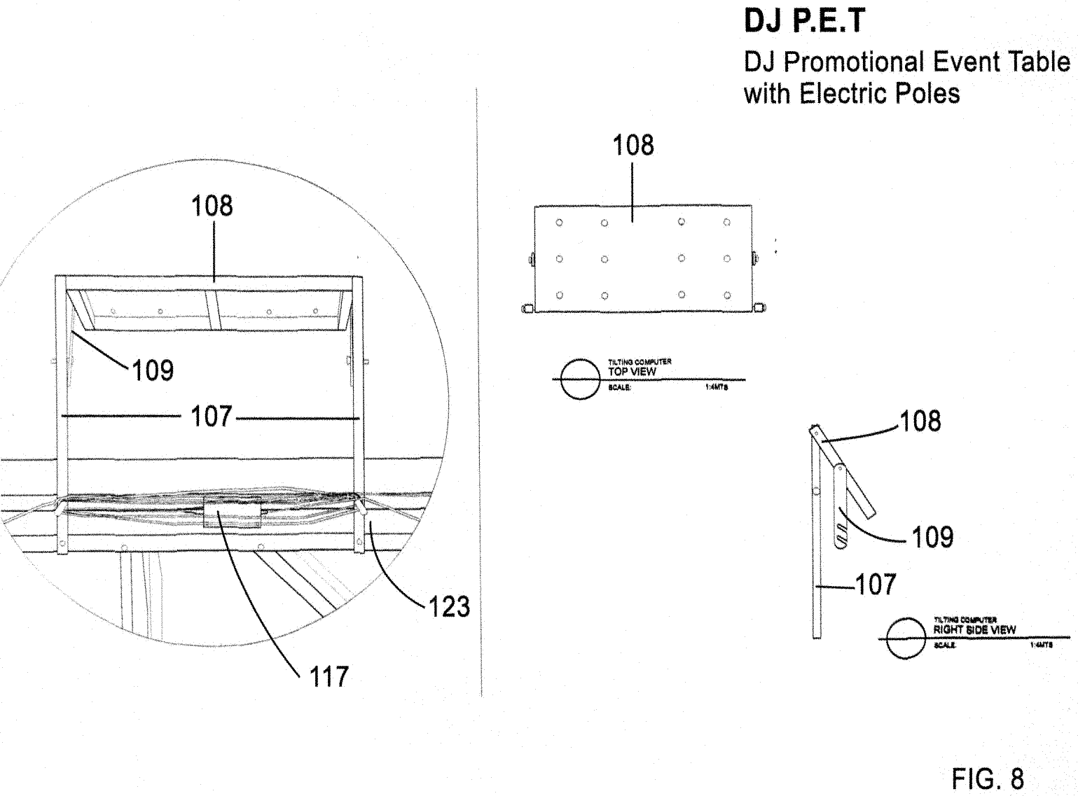

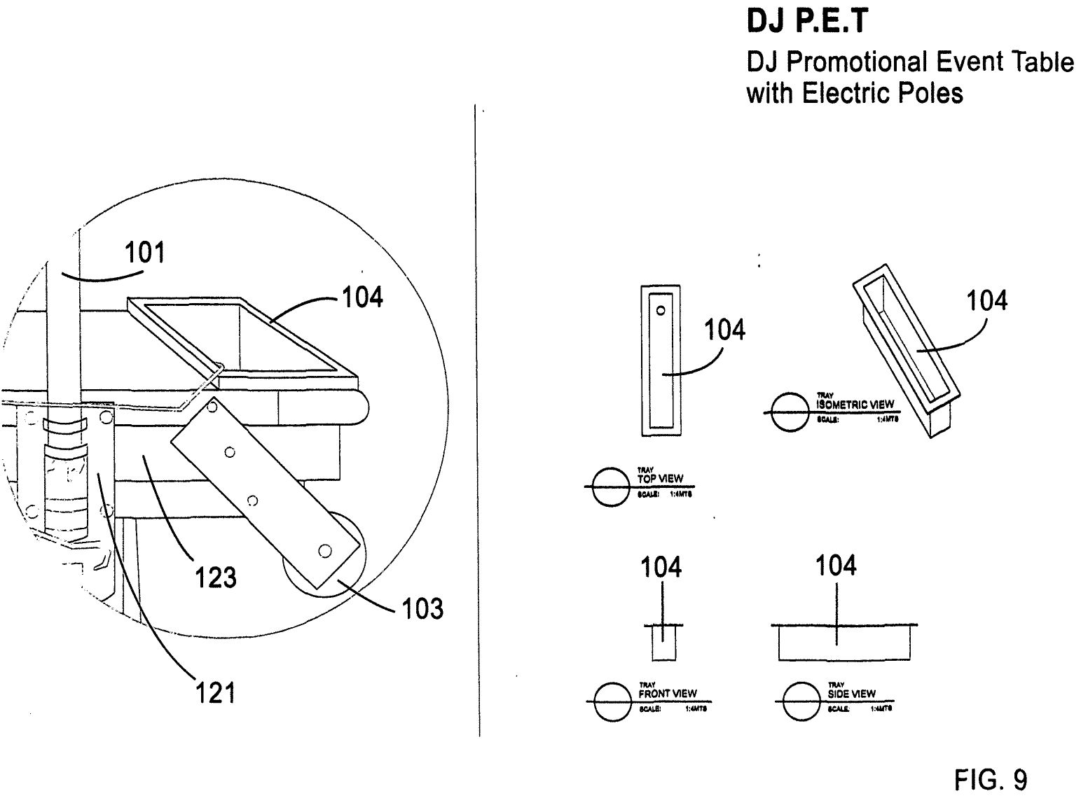

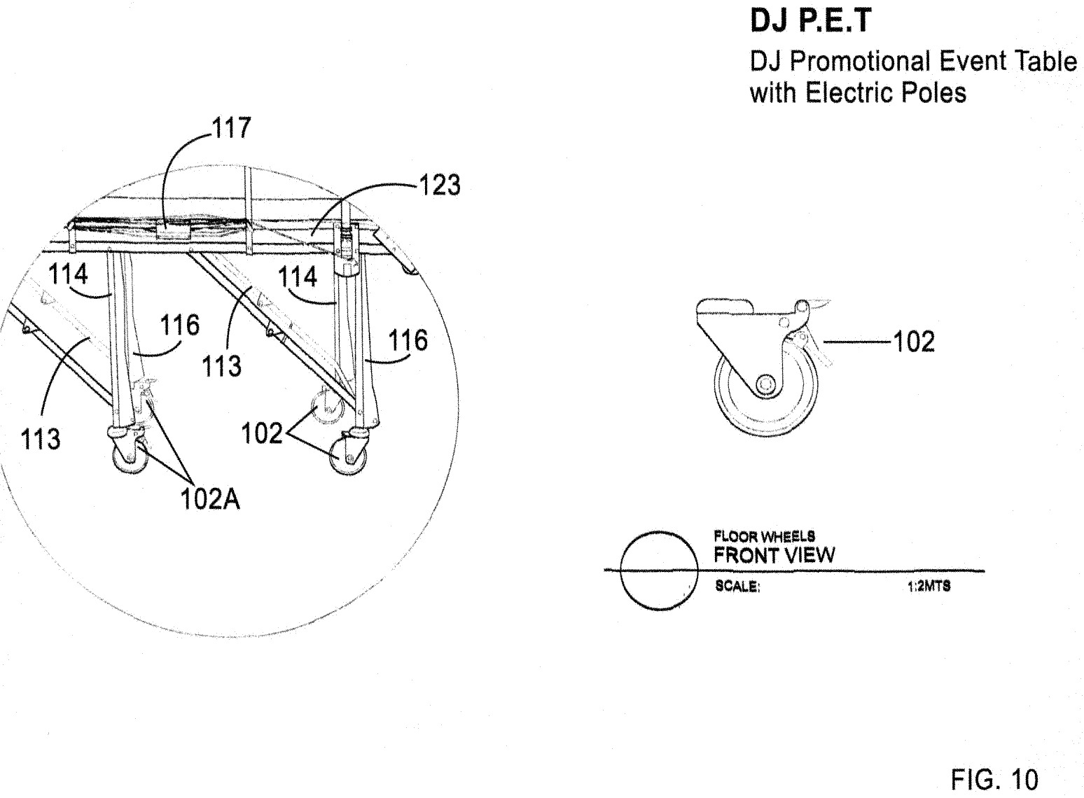

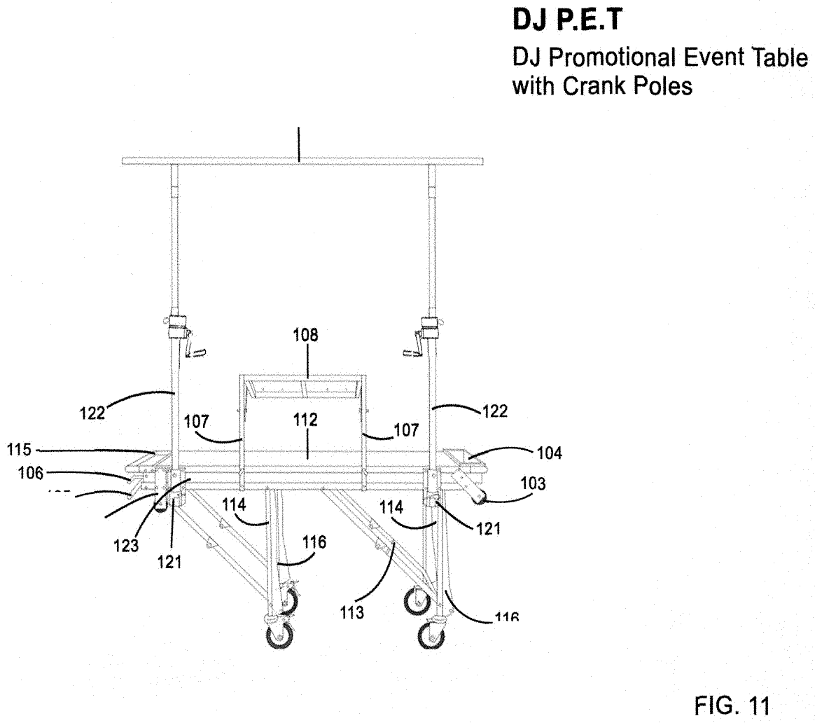

1 FIG. 1 is an overview of the invention with aluminum table top on it.

FIG. 1.1 It's angle where the Levers or 105 and it's lock or 106 are visible. The rear 113 are attached to rear 124 or legs support while both 105 are also attached to rear and front 113. both 105 needed to be press when loading the DJ table to vehicle. Once they are pressed all 114 or legs will fold. The 106 is unlock position. 106 must turned perpendicular position to Lock the 105.

FIG. 1.2 An image of the invention where both tilting laptop computer holder and the poles are attached, poles here are extended. Both 107 are mounted on the 123 or side frame while two 107 are both attached to 108 and 109 with clevis pins.

FIG. 1.3 An image of the invention where both tilting laptop computer holder and the poles are attached, poles here or 101 are retracted.

FIG. 1.4 An angle where two of the roll-in roll-out wheels or 103 are visible. The 113 or foldable brackets are attached to the 124 or leg support and both 105 are connected too as folding controller.

FIG. 1.5 The table frame 123 was put together with long bolts and nuts or 110 and riveted together with 111 and placed the 112 aluminum top which was also riveted.

2 FIG. 2 The 114 is inserted like a ring between 123 or frame and brace 110.

The 102 are attached to front 114 and with secured bolts and nuts.

The swiveling 102a are attached in the rear 114 and locked with bolts and nuts. Both 102 and 102a are lockable.

The 117 or electric adapter is hanging on the front 123 and both 101 are already connected to 117.

3 FIG. 3 An image of electrical kit for 101 seen @ FIG. 2.

The electrical kit is compose of 118 or transmitter and receiver for 119 or wireless remote control. It also shows here the 120 or cable connectors to 101 from 117.

4 FIG. 4 The invention was completely assembled and 119 is highlighted. The 101 can be Extend or retract in a press of 119 for desired direction.

5 FIG. 5 The 123 has mounting attachment or 121 for 101. The 101 then be attached together With 100 and secured with clevis pins.

6 FIG. Each 114 or legs has bumper guard or 116 to protect both vehicle and the 114 from being Scratched.

7 FIG. 103 is a roll-in roll-out fork with wheels for easy loading and unloading.

The double sided 103 is made of aluminum flat bar with 3 inches diameter rubber wheels. 103 are attached to 123 and secured with bolts and nuts.

8 FIG. 8 It shows the 107 lower part are attached on the 123 with bolts and nuts, while The 107 upper part is attached to 109 and 108 and secured with clevis pins.

9 FIG. 9 The 104 is a side tray place on the front side of 123. This 104 was designed to store Either 117 and 118 seen from FIG. 3 or can be use as electrical surge outlet.

10 FIG. 10 Both 102 and 102a are lockable, but only 102a are swiveling for easy maneuver.

11 FIG. 11 The 122 are manual detachable crank poles as spare poles in case electrical poles are broken or not available.

### Dimensions

Total weight: 77 lbs.
Load capacity: 250 lbs.
Lighting T-bar capacity: 50 lbs.
Width is 21 inches
Table top height: 33 Inches
Length: 56 inches
With handles: 64 inches
Tilting computer table: 10×21 inches
Tilting computer holder height: 48 inches

1. The invention claimed is a self-propelled DJ Promotional Event Table comprising:
a flat surface on which equipment and other items may be placed on;
a set of foldable legs with wheels and individual locks; and
a pair of linear actuators or crank semi-permanent adjustable and detachable poles.

2. The device of claim 1, further comprising:
an adjacent container;
an attached elevated desk; and
an attached t-bar.

3. A self-propelled table as in claim 1 wherein the said adjustable, detachable poles and said foldable legs with wheels are attached to the said flat surface.

4. A self-propelled table as in claim 1 wherein said pair adjustable poles are either modified by a crank, or an electronic remote control.

5. A self-propelled table as in claim 1 wherein said pair of adjustable poles are configured to support hanging lighting, banners and equipment.

6. A self-propelled table as in claim 1 wherein said foldable legs with wheels are lockable.

7. A self-propelled table as in claim 2 wherein the attached elevated desk is secured to the poles by a set of bolts with nuts, pins and metal bars.
